(19) United States
(12) Patent Application Publication
(10) Pub. No.: US 2014/0207567 A1
(43) Pub. Date: Jul. 24, 2014

(54) Cross Channel Conversion Tracking System and Method

(71) Applicant: Digital River, Inc., Minnetonka, MN (US)

(72) Inventors: Christopher Michael Gould, Chanhassen, MN (US); Eric William Lanser, Minneapolis, MN (US); Jeffrey J. Dahlby, Minnetonka, MN (US); Jason R. Nyhus, Hopkins, MN (US)

(73) Assignee: Digital River, Inc., Minetonka, MN (US)

(21) Appl. No.: 14/160,512

(22) Filed: Jan. 21, 2014

Related U.S. Application Data
(60) Provisional application No. 61/753,961, filed on Jan. 18, 2013.

(51) Int. Cl. G06Q 30/02

(52) U.S. Cl. CPC G06Q 30/0246
USPC 705/14.45

(57) ABSTRACT

A cross channel conversion tracking system and method provides online marketers with information regarding which ads lead to conversion transactions, such as purchases. The system and method provides means to track purchases made when a particular user receives a marketing exposure on one device or channel but purchases on another device or channel. A cross channel conversion tracking system and method may be comprised of at least a data collection module, a data integration module, and a communications module with sub-modules as described. A data collection module may collect data on marketing exposures, post-purchase online interactions and device associations. A communications module may be used to retrieve data from local databases or third party systems when available, to allow for cross-device and cross-channel tracking. A data integration module may associate the various types of data to present a picture of marketing expenditure efficiency.

### FIELD OF THE INVENTION

The field of invention relates generally to ecommerce marketing. In particular, it relates to determining the efficiency of online advertisements.

### BACKGROUND OF THE INVENTION

Forbes magazine recently reported that online ad spending topped $100 billion in 2012, and online ad sales will rise 15.1%, to $118.4 billion in 2013 and will comprise more than a quarter of all ad dollars spent by 2016. While this type of prediction may not always pan out, it does show that online advertisers spend a lot of money in this media and that, in all likelihood, that amount will increase greatly in the coming years.

One challenge for online marketers is determining the true return on investment (ROI) of online marketing efforts. Many people who frequently do internet research on items they would like to purchase are still reluctant to make a purchase online, particularly due to privacy or security concerns. There is currently little insight into how online marketing drives offline revenue or understanding of how marketing impacts other online retailers. As a result, it is difficult to understand the true impact of a company's marketing spend.

Systems that track online purchases from an online ad (“conversions”) are well known in the computer arts. For example, online marketers can determine how a customer came to purchase an item when the customer clicks on an ad on a web page or in an email. Clicking on the ad fires a piece of tracking code which will collect information regarding the users experience and behavior. When the customer performs a conversion event such as a purchase, another piece of code fires, for example, on the store's thank you page, collecting the information regarding the conversion.

Sometimes the conversion does not occur online. A customer may view the ad online but perform the conversion event offline, such as by phone or in a physical store. In that case, some systems allow the marketer to track the sale offline, associate it with the information collected for an ad click, and upload that information into a conversion tracking system. [symbol] data. However, such tracking systems require a great deal of manual data collection and analysis.

A cross-channel conversion tracking system and method provides a solution to these current problems in the area of online sales and provides other benefits that will become apparent on reading the following specification.

### BRIEF SUMMARY

A cross-channel conversion tracking system and method ties marketing exposure to post-purchase information in order to reveal the true ROI of online marketing efforts. A data collection module collects data related to both marketing exposure and post-purchase activities. A data integration and analysis module marries the marketing exposure and post-purchase activity data to present a view of the success of online marketing efforts in leading to product purchases. Products may be digital or physical; purchases may be online or offline.

In a preferred embodiment, users may be exposed to online marketing materials including ads and product pages. Data is collected using data collection methods such as cookies or clicks. When a purchase occurs online, that information is collected as well. Additional information may be collected during post-purchase transactions, such as registration, installation and other activities. Additional data regarding cross-device transactions, including device ownership, may be collected from third party providers or local databases used to collect device data, using an API. A data integration module uses business rules and logic to link the marketing exposure to the post-purchase transaction to identify which, and what, ads or product pages the customer was exposed to prior to making the purchase, and how the purchase was made.

### BRIEF DESCRIPTION OF THE DRAWINGS

FIG. 1 is an illustration of the context in which a cross channel purchase tracking system and method is used

FIG. 2 is an illustration of the components of an electronic computing device used to make internet purchases included in a cross channel conversion tracking system and method

FIG. 3 is an illustration of the components of a typical ecommerce system using a hosting, or providing services to, an online store

FIG. 4 is a flowchart illustrating the steps in the process of cross-channel conversion tracking

FIG. 5 is an illustration of cross-channel conversion tracking when a user receives a marketing exposure on one device, and purchases online with another device

### DETAILED DESCRIPTION

Online marketers wish to know whether the marketing dollars they are spending are resulting in sales. This has become a challenge due to the ever-increasing and varied marketing channels and options for purchase. For example, product ads and product research may be viewed on any connected device, including a user's internet-enabled phone, iPad, laptop or other internet-enabled device. The product may eventually be purchased online via any one of these devices, or may be purchased physically at a brick and mortar store or ordered over the phone. A cross channel tracking system and method allows a marketer to collect data regarding marketing exposure and associate it with subsequent ownership of a purchased product.

Typically, when a user searches for a product and clicks on an internet search ad an identifier is installed on that user's browser. The user may then purchase the item at the linked store, at another store, or offline, such as at a local retailer. As the user installs the purchased product on his/her computing device, the last step of the installation process opens a browser window with a “thank you for installing” page. On this thank you page an ad tracking pixel is placed. Because an ad identifier was dropped on this user previously, a connection is made between the original ad identifier and the subsequent tracking pixel on the thank you page that opened after the installation. Reporting now shows that a sale was generated from one of the internet ads that wouldn't have been recordable before adding the thank you page pixel to the installation process upon completion of the install. Such a process allows the marketer to track orders that are the result of internet ads even if the purchase did not occur on the marketer's website.

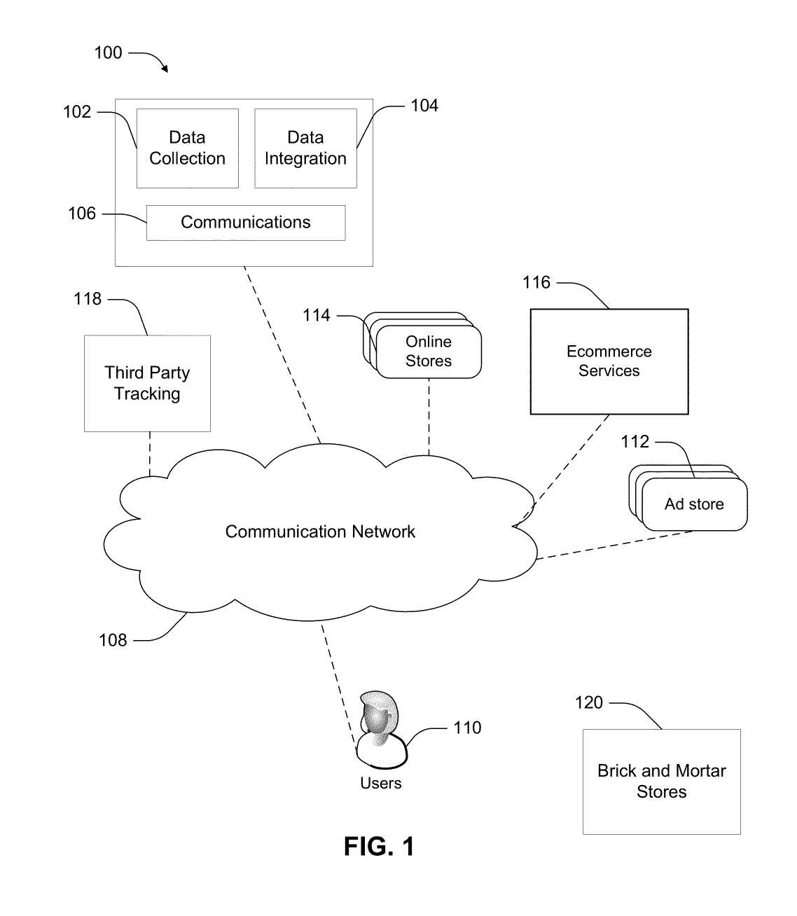

The ecommerce environment in which a cross channel conversion tracking system 100 operates is necessarily composed of a number of interconnected, electronic components. These components and their relationships are illustrated in FIG. 1. The cross channel tracking system and method is comprised of at least three components: a data collection module 102 with sub-modules for providing online advertisements and conversion tracking programs, a data integration module 104 which further comprises a database for business rules and logic for making associations among data, and a communications module 106. The system is connected to a communications network, such as the internet 108. Internet merchants may host their own stores 112, 114 or may contract with an ecommerce system provider 116 for any number of services. These services could be as limited as a simple shopping cart service, or as comprehensive as hosting the entire store along with marketing and analytics, logistics, and more. Internet merchants frequently market their products by placing online ads using a number of digital marketing methods, including affiliate, search engine marketing and display ads. A user 110, (e.g. a purchaser or shopper) accesses the internet 108 using a computing device such as a laptop computer, desktop computer or mobile device. The user 110 may perform a search for the product or go directly to a store to get product details, pricing, etc. If an advertisement is available, the user may click on that ad and follow its link to the posting store. If the user purchases from the store, a direct link can be made from the ad to the store using traditional tracking methods. However, if the user clicks on the ad but makes a purchase elsewhere, such as through another, possibly unrelated store 112, or a brick and mortar store 120, or even online using a different device, the marketer is currently not able to track the effectiveness of the ad by determining whether the user actually purchased the item. A cross-channel conversion tracking system and method overcomes these issues to provide the marketer with a more accurate picture of its advertising expenditures.

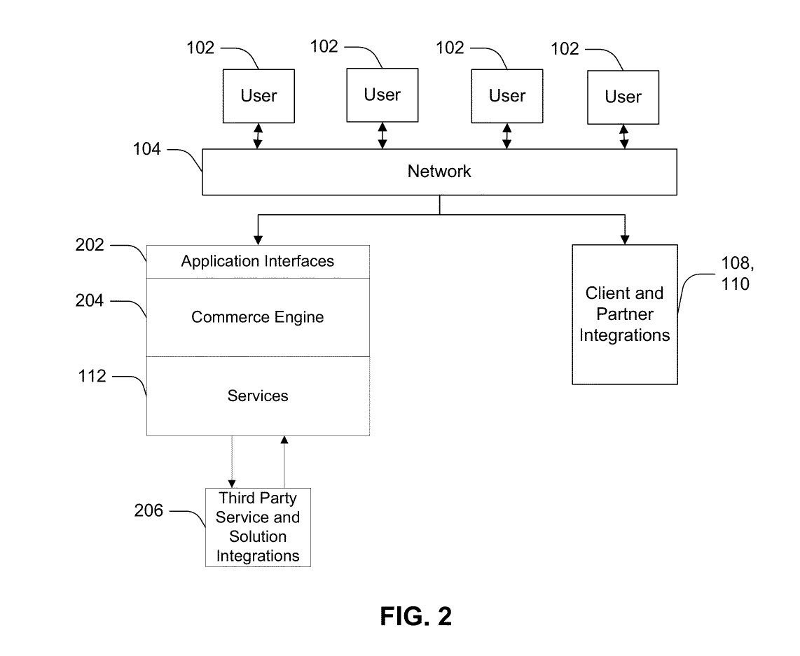

Ecommerce systems 116 are hosted on servers that are accessed by networked (e.g. internet) users through a web browser on a remote computing device. One of ordinary skill in the art will recognize that a “host server” is a computing system that is accessed by a user, usually over cable or phone lines, while the user is working at a remote location. The system that contains the data is the host, while the computing system at which the user sits is the remote system. Software modules may be referred to as being “hosted” by a server. In other words, the modules are stored in memory in the system for execution by a processor. The various components of an exemplary ecommerce service provider 112 are illustrated in FIG. 2. The ecommerce application comprises application interfaces 202, a commerce engine 204, services 116 such as marketing and web analytics, third party services and solutions 206 and client and partner integrations 112, 114. The application interfaces 202 may include tools that are presented to a user for use in implementing and administering online stores and their functions, including, but not limited to, store building and set up, merchandising and product catalog (user is a store administrator or online merchant), or for purchasing items from an online store (user is a shopper). For example, users 102 may access the ecommerce application suite from a computer workstation or server, a desktop or laptop computer, or a mobile device. A commerce engine 204 comprises a number of components required for online shopping, for example, modules with instructions stored in memory that when executed by the processor perform functions related to customer accounts, orders, catalog, merchandizing, subscriptions, tax, payments, fraud, administration and reporting, credit processing, inventory and fulfillment. Services 112 support the commerce engine and comprise one or more of the following: analytics, fraud, payments, and enterprise foundation services (social stream, wishlist, saved cart, entity, security, throttle and more). Third party services and solutions 206 may be contracted with to provide specific services, such as address validation, payment providers, tax and financials. Client integrations 108 may be comprised of client external systems (customer relationship management, financials, etc), sales feeds and reports and catalog and product feeds. Partner integrations 108 may include fulfillment partners, client fulfillment systems, and warehouse and logistics providers.

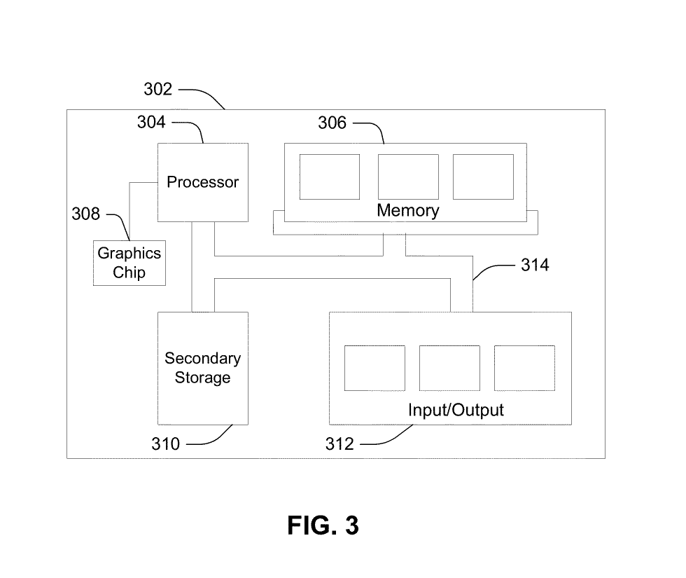

Referring to FIG. 3, an electronic computing device 302, such as a laptop, tablet computer, smartphone, or other mobile computing device typically includes, among other things, a processor (central processing unit, or CPU) 304, memory 306, a graphics chip 308, a secondary storage device 310, input and output devices 312, and possibly a display device, all of which may be interconnected using a system bus 314. Input and output may be manually performed on sub-components of the computer or device system such as a keyboard or disk drive, but may also be electronic communications between devices connected by a network, such as a wide area network (e.g. the Internet) 108 or a local area network. The memory 306 may include random access memory (RAM) or similar types of memory. Software applications, stored in the memory 306 or secondary storage 310 for execution by a processor 304 are operatively configured to perform the operations in one embodiment of the system. The software applications may correspond with a single module or any number of modules. Modules of a computer system may be made from hardware, software, or a combination of the two. Generally, software modules are program code or instructions for controlling a computer processor to perform a particular method to implement the features or operations of the system. The modules may also be implemented using program products or a combination of software and specialized hardware components. In addition, the modules may be executed on multiple processors for processing a large number of transactions, if necessary or desired.

A secondary storage device 310 may include a hard disk drive, floppy disk drive, CD-ROM drive, DVD-ROM drive, or other types of non-volatile data storage, and may correspond with the various equipment and modules shown in the figures. The processor 304 may execute the software applications or programs either stored in memory 306 or secondary storage 310 or received from the Internet 108 or other network. The input device 312 may include any device for entering information into computer, such as a keyboard, joy-stick, cursor-control device, or touch-screen. The display device may include any type of device for presenting visual information such as, for example, a computer monitor or flat-screen display. The output device may include any type of device for presenting a hard copy of information, such as a printer, and other types of output devices include speakers or any device for providing information in audio form.

Although the computer, computing device or server has been described with various components, it should be noted that such a computer, computing device or server can contain additional or different components and configurations. In addition, although aspects of an implementation consistent with the system disclosed are described as being stored in memory, these aspects can also be stored on or read from other types of computer program products or computer-readable media, such as secondary storage devices, including hard disks, floppy disks, or CD-ROM; a non-transitory carrier wave from the Internet or other network; or other forms of RAM or ROM. Furthermore, it should be recognized that computational resources can be distributed, and computing devices can be client or server computers. Client computers and devices (e.g.) are those used by end users to access information from a server over a network, such as the Internet. These devices can be a desktop or laptop computer, a standalone desktop, or any other type of computing device. Servers are understood to be those computing devices that provide services to other machines, and can be (but are not required to be) dedicated to hosting applications or content to be accessed by any number of client computers. Web servers, application servers and data storage servers may be hosted on the same or different machines. They may be located together or be distributed across locations. Operations may be performed from a single computing device or distributed across geographically or logically diverse locations.

Client computers access features of the system described herein using Web Services. Web services are self-contained, modular business applications that have open, Internet-oriented, standards-based interfaces. According to W3C, the World Wide Web Consortium, a web service is a software system “designed to support interoperable machine-to-machine interaction over a network. It has an interface described in a machine-processable format (specifically web service definition language or WSDL). Other systems interact with the web service in a manner prescribed by its description using Simple Object Access Protocol (SOAP) messages, typically conveyed using hypertext transfer protocol (HTTP) or hypertext transfer protocol secure (HTTPS) with an Extensible Markup Language (XML) serialization in conjunction with other web-related standards.” Web services are similar to components that can be integrated into more complex distributed applications.

A cross channel conversion tracking system and method may be comprised of at least a data collection module 102, a data integration module 104, and a communications module 106 as described above. A data collection module 102 may collect data on marketing exposures, post-purchase online interactions and device associations. The communications module 106 is used to retrieve data from local databases or third party systems when available. A data integration module 104 may associate the various types of data to present a picture of marketing expenditure efficiency.

The data collection module 102 may contain an online marketing module installed in memory which when executed by a processor performs operations of installing an identifier on a computing device browser in response to a user click. It may also contain a software installation program which when installed on the local computing device fires a tracking program which may locate the identifier previously installed on the device. A data integration module 104 associates the data collected by viewing ads with data collected through conversion (e.g. purchase, completion of a form, etc.) transactions to identify the which marketing exposures may have led to the conversion.

A data collection module 102 collects marketing exposure data in a number of different ways. By way of example and not limitation, the data collection module 102 may collect data from website (e.g. online store, informational product page, marketing campaign page, corporate page, brand page, social media page, product video page, web forum page) views and interactions, paid search ad click, display banner click, email link click, affiliate link click, display banner view, email open, and/or website feature interaction (e.g. play of a video, use of an interactive tool, creation of a shopping basket). Identifying information may be stored on the user's device or on a web server. Each exposure may be logged or the earliest and most recent marketing exposures stored (locally or on a web server) in association with an individual user. Secondary details about the marketing exposure type may also be recorded.

The data collection module 104 also may collect data related to post-purchase online interactions. Examples of post-purchase online transactions include web pages triggered after software installation (e.g. a “thank you for installing” or “please register” or “see other BRAND-X products” page), a product registration (initial, middle or complete page), product-related software download (e.g. mouse software, ink monitor, etc) or user-visible web page for a similar process, product-driver downloads (e.g. mouse hardware driver) or user-visible web page for this process, product-related account creation (e.g. smart TV account, product user group sign up), product help page views, or product warranty applications. Each post-purchase interaction is logged in association with the individual user and any secondary data collected.

As is illustrated in FIG. 1, the cross channel conversion tracking system and method includes a communication module which allows the data collection module to interface with either third party systems or local database and system using an application programming interface or other communications program that may provide information associating devices with users, which may provide valuable information for tying a marketing exposure to a particular purchase.

Secondary data may be collected along with post-purchase occurrences. This data is often directly valuable as survey information or to provide dimensions to collected data. For example, time and place of purchase, time of registration/installation/etc; other products user indicates he/she is interested in; other products user purchased with product; other products user already owns; user-indicated marketing exposure (“how did you learn about brand X or product Y).

A data integration module 104 may use business rules and logic to provide the marketer with valuable marketing information. Logged post-purchase interactions and marketing exposures are of primary value where an individual user is in common between the two types of data. The number of such cases is the primary data ultimately utilized but other data can be of value as well. For example, the data integration module 104 may measure cases where marketing drives a purchase. The date of purchase is indicated by the user as part of the post-purchase process (e.g. registration, installation, account setup, driver download, etc.). Business logic may include capturing only marketing exposures that have occurred before the indicated purchase date as being associated to the purchase. The date of registration or installation is logged. Assumptions or outside data may be applied to determine whether marketing is credited for the purchase based on relative date of marketing to time of post-purchase event. Also, marketing occurring after purchase may be measured. Date-centric methods described above, but used in reverse to measure occurrence of marketing expense after purchase occurred may be measured. This data can be used to refine marketing performance measurements, and optimize marketing campaigns.

Collected secondary data may be used to refine measurement or optimize marketing. For example, sales credit may be attributed to user indicated marketing exposures in preference to other marketing exposures. Secondary data can be used to include or exclude users from marketing campaigns, such as including them in future campaigns for the same type of marketing exposure that was influential but for other products or future product versions or include them in future campaigns co-branded with the retailer from whom they purchased. Alternatively, customers who have already purchased particular products may be excluded from marketing campaigns in order to conserve resources for new customers.

In one embodiment, the system and method may place marketing exclusion trackers on the post-purchase page. Such an exclusion tracker may be used to exclude a particular set of users from future marketing, for a period of time or permanently. Alternatively, marketing inclusion trackers may be placed on a post-purchase page. This would include a set of users in targeted campaigns, such as for complimentary products, consumables, etc.

The data integration module 104 may be used to extrapolate from measured data to full picture using statistical methods. For example, with manufacturer-provided information about total sales and total registrations, the system can extrapolate from collected data to an entire population. As an example, assume the manufacturer reports that they sold 10,000 units in a given month. The cross-channel tracking system and method may indicate that there were 5,000 individuals who each registered one product. Further assume that 1,000 users were measured as exposed to a particular marketing vehicle. The system can both directly draw conclusions about those 1,000 users and estimate that 2,000 (1,000*(10,000/5,000)) total users were associated with that particular marketing vehicle.

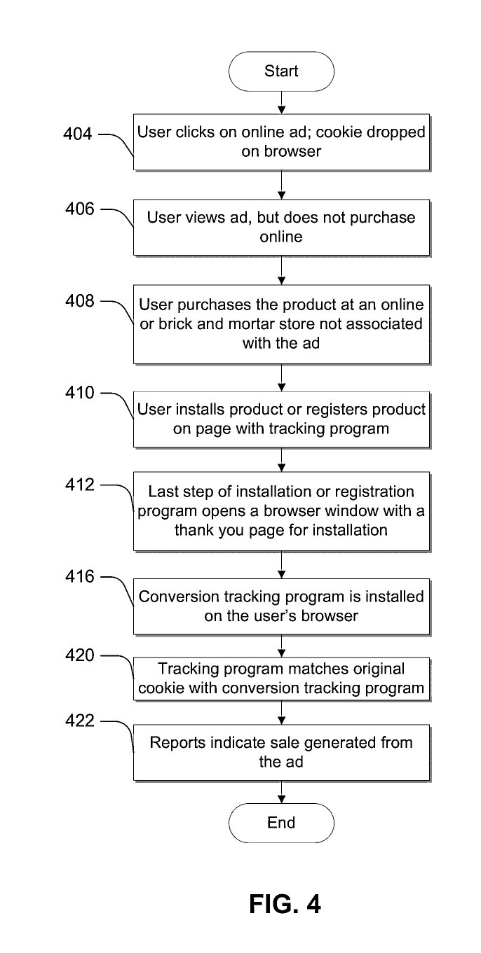

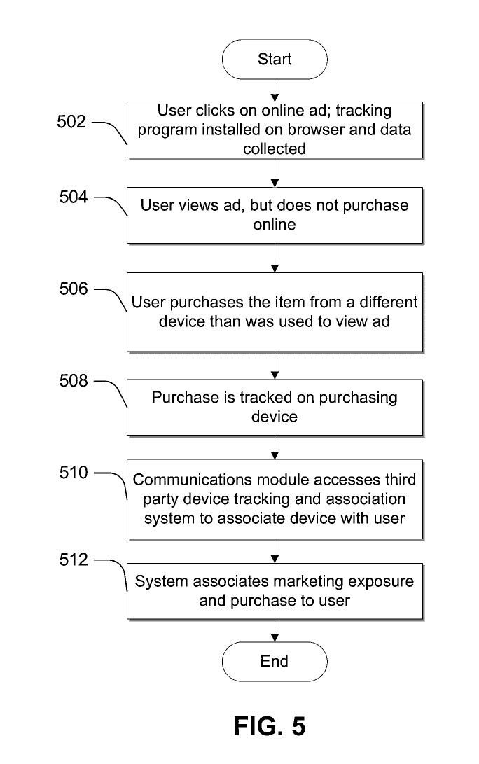

FIGS. 4 and 5 illustrate examples of cross channel conversion tracking system and method. Referring to FIG. 4, a user 110 of a computing device 302 uses a web browser to view an informational page for a digital product. A cookie is dropped on the web browser 404. The user may view the informational page, but decline to purchase online at the store offering the ad 406. The user then may visit an online or offline store, distinct from the one hosting the informational page, and make the purchase 408. The user 110 installs the product on the same computer on which the ad was viewed 410, or, optionally, a device associated with the same user through tracking or statistical means, or registers that product on a page with a tracking program. The last step of the installation process opens a browser window with a “thank you for installing” page 412. A tracking feature on this thank you page, is called 414 by the user's browser. Because a tracking program was installed on this browser previously 416, the tracking program initiates a report to a data integration system 104 and a connection is made between the original cookie or tracked device and the subsequent tracking program on the thank you page that opened following installation. Reporting 418 now shows that the marketer generated a sale from a view of the informational page that wouldn't have been otherwise recordable. This is how orders can be tracked as resulting from views of the informational pages even if the purchase did not occur on the client's website.

FIG. 5 provides a similar illustration of this process. In FIG. 5, the user clicks on an online ad; a conversion tracking program is installed on the user's browser and data is collected 502 as the user views the ad 504. The user later purchases the item online from a different device than was used to view the ad 506. The purchase is tracked on the purchasing device 508. A 106 module accesses a third party or local device tracking and association system in order to associate the device with the user 510. The data integration module then associates the marketing exposure with the online purchase for the user 512.

Another example may illustrate a more complex association between marketing exposure and post-purchase interaction. A user may search for products on a smart phone. The user clicks on an ad or navigates to a product page to view product specifications. Identifying information is placed on the users browser as a result of these interactions and data is collected that provides information about the user. The user may then make a purchase from a desktop computer. Data may be collected from the thank you, or other informational, page that will be associated with the sale. In order to tie the user's marketing exposure to the purchase, the communications module 106 may reach out to a third party service or local database which collects information related to users associations with various devices. The marketing exposure and purchase data are then associated with the user of the devices.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed.

1. A cross-channel conversion tracking system, comprising:
an online marketing module operatively configured to provide online advertisements, each advertisement configured to install an identifier on a local computing device browser when a user clicks on one of the advertisements;
an installation or registration program which when installed on the local computing device activates a conversion tracking program which locates an identifier related to a previously viewed online advertisement for the software; and
a tracking system operatively configured to receive the data from the marketing identifier and the conversion pixel and providing a link between the two in the tracking system database and providing a report or display that allows an internet marketer to view the channel from which the advertised item was purchased.

2. A cross-channel conversion tracking system, comprising:
an online marketing module operatively configured to provide online advertisements, each advertisement configured to install an identifier on a local computing device browser when a user clicks on one of the advertisements;
a software installation program which when installed on the local computing device fires a conversion tracking program which locates an identifier related to a previously viewed online advertisement for the software;
a communications system operatively configured to retrieve data from a third party system or local database based on an identification of the users of a device; and
a tracking system operatively configured to receive the data from the marketing identifier and the conversion tracking program and providing a link between the two in the tracking system database and providing a report or display that allows an internet marketer to view the channel from which the advertised item was purchased.

3. A method for associating marketing exposure with a subsequent purchase, comprising:
installing a marketing identifier on a user's web browser in response to user input;
executing a conversion tracking program in response to user input;
receiving the data from the marketing identifier and the conversion tracking program; and
associating the marketing identifier with the data from the conversion tracking program two in a tracking system database.

4. The method of claim 3 comprising the further steps of:
communicating with a database providing information associating devices with particular users; and
providing a report or display that allows an internet marketer to view the channel from which the advertised item was purchased.

5. The method of claim 3 where the conversion tracking program is executed in response to a user completing post-purchase activities.
